(19) United States
(12) Patent Application Publication
(10) Pub. No.: US 2005/0224554 A1
(43) Pub. Date: Oct. 13, 2005

(54) Stapler with device for holding stapler open

(75) Inventors: David W. Kirby, Lemont, IL (US); Bikramjeet S. Sohi, Buffalo Grove, IL (US); Stephen J. Gaynes, McHenry, IL (US); Richard J. Page, Lake Villa, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 11/097,091

(22) Filed: Apr. 1, 2005

Related U.S. Application Data
(60) Provisional application No. 60/559,317, filed on Apr. 2, 2004.

(51) Int. Cl. B25C 5/02

(52) U.S. Cl. 227/134

(57) ABSTRACT

A stapler and a method for holding a stapler open to inhibit the stapler from closing unexpectedly. The stapler includes a base, a magazine for receiving staples, and a cover assembly pivotable between an open position and a closed position with respect to the magazine. The stapler also includes a holding device coupled to the stapler that holds the cover assembly in the open position with respect to the magazine when the cover assembly is pivoted to the open position.

### CROSS-REFERENCE TO RELATED APPLICATIONS

This application claims priority to U.S. Provisional Patent Application No. 60/559,317, filed Apr. 2, 2004, the entire contents of which is incorporated by reference herein.

### FIELD OF THE INVENTION

The invention relates to staplers.

### BACKGROUND OF THE INVENTION

Manual desk staplers are known to include some way to access the staple holding chamber to facilitate adding more staples to the stapler. In some staplers, the staple holding chamber, also known as the magazine, slides out from under the top case. In other staplers, the top case pivots away from the magazine, exposing the magazine to allow more staples to be added.

### SUMMARY OF THE INVENTION

Prior art staplers that allow access to the magazine by pivoting the case away from the magazine usually lock the case in the closed position through the interaction of the case and the magazine. This interaction can be overcome by the user so that the case pivots open. Once the case is opened, the case generally stays open only due to gravity on the case.

The present invention provides a stapler including a base and a magazine for receiving staples, the magazine being coupled to the base. The stapler also includes a cover assembly coupled to the base that is pivotable between an open position and a closed position with respect to the magazine. A holding device is also coupled to the stapler that holds the cover assembly in the open position with respect to the magazine when the cover assembly is pivoted to the open position.

In one embodiment, the cover assembly includes a case coupled to a cover. In another embodiment, the holding device includes a detent on one of the magazine and the cover assembly and a protrusion on the other of the magazine and the cover assembly that cooperates with the detent to hold the cover assembly in the open position.

The invention also provides a method of holding a stapler open to inhibit the stapler from closing unexpectedly, the stapler including a base, a staple magazine, and a cover assembly. The method includes biasing the cover assembly toward a closed position with respect to the staple magazine, and pivoting the cover assembly toward an open position with respect to the staple magazine. The method also includes overcoming the bias toward the closed position such that a user has access to the staple magazine, and engaging the cover assembly and the staple magazine to thereby hold the cover assembly in the open position.

Other features and advantages of the invention will become apparent to those skilled in the art upon review of the following detailed description, claims, and drawings.

### BRIEF DESCRIPTION OF THE DRAWINGS

FIG. 1 is a rear perspective view illustrating a stapler embodying the invention.

FIG. 2 is a perspective view of the stapler of FIG. 1, showing the stapler in the open position.

FIG. 3 is a perspective view of the stapler of FIG. 1, showing the stapler in the partially closed position.

FIG. 4 is a partial perspective view of a device for holding the stapler in the open position.

FIG. 5 is a partial perspective view of the magazine of the stapler of FIG. 1.

FIG. 6 is a partial perspective view of the case of the stapler of FIG. 1.

FIG. 7 is a partial cross-section view of the stapler of FIG. 1, showing the stapler in the closed position.

FIG. 8 is a partial cross-section view of the stapler of FIG. 1, shown in the open position.

FIG. 9 is a partial perspective view taken from the underside of a sub-assembly of another stapler embodiment.

FIG. 10 is a partial cross-section view of the stapler sub-assembly of FIG. 9, shown in the closed position.

FIG. 11 is a partial cross-section view of the stapler sub-assembly of FIG. 9, shown in the open position.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including,” “having,” and “comprising” and variations thereof herein is meant to encompass the items listed thereafter and equivalents thereof as well as additional items.

### DETAILED DESCRIPTION OF THE PREFERRED EMBODIMENT

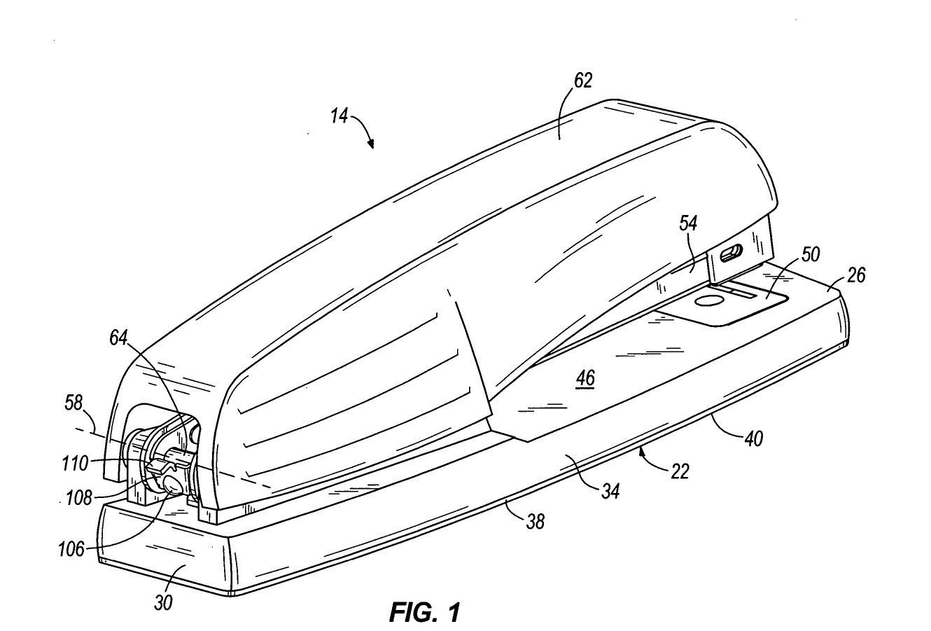

In the embodiment illustrated in FIG. 1, the stapler 14 is a manual desktop-type stapler, however, the invention can be practiced with substantially any type of stapler, including, but not limited to, manual hand-held or upright staplers, manual heavy-duty staplers, and all forms of electric staplers, including desktop-type, heavy-duty, and hand-held electric staplers.

The illustrated stapler 14 includes a base 22 having a front end 26, a rear end 30, and opposite sides 34. A bottom 38 of the base is at least partially covered by a slipper or pad 40 that helps stabilize and minimize sliding movement of the stapler 14 on a support surface (not shown). The base 22 further includes a top surface 46 for receiving and supporting a stack of sheets (not shown) to be stapled. An anvil 50 is supported by the top surface 46 for clinching staples driven through the stack of sheets.

A staple magazine 54 is pivotally connected to the rear end 30 of the base 22 about a pivot axis 58, as is understood in the art. A cover 62 is also pivotally connected to the base 22 about the pivot axis 58, and is capable of pivoting both with the magazine 54 and with respect to the magazine 54 during stapling operations. The cover 62 also pivots away from the magazine 54 to facilitate re-filling the magazine 54 with staples.

A pivot pin 64 extending substantially between the sides 34 of the base defines the pivot axis 58. Those skilled in the art will understand that the illustrated construction of the pivot pin 64 is only one possible manner for pivotally interconnecting the base 22, the magazine 54, and the cover 62. Other pivot configurations, including a pivot axis defined in part by a pivot plate (not shown) having a base portion and opposite upstanding mounts, can also be used.

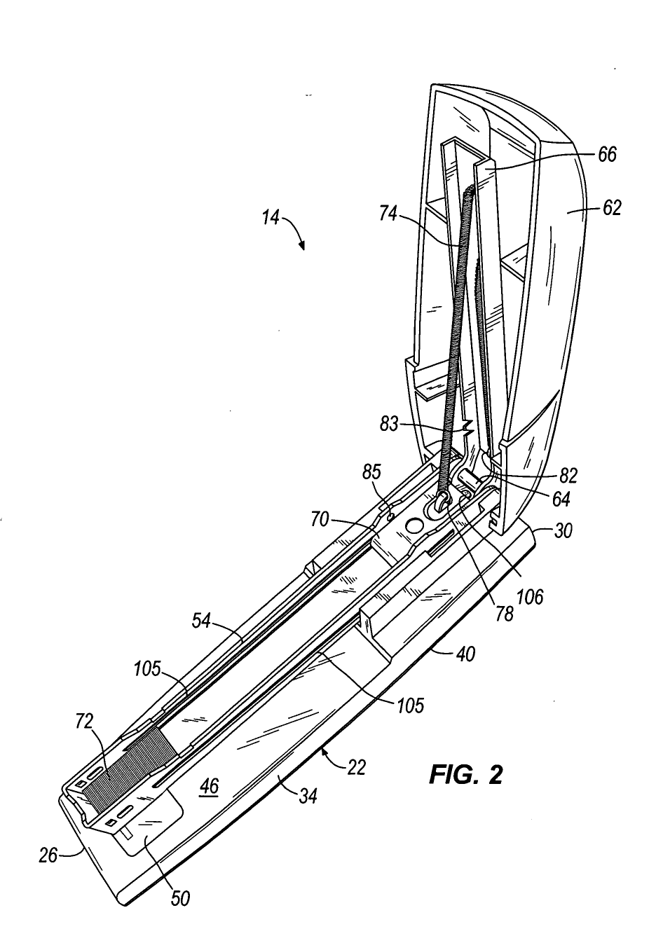

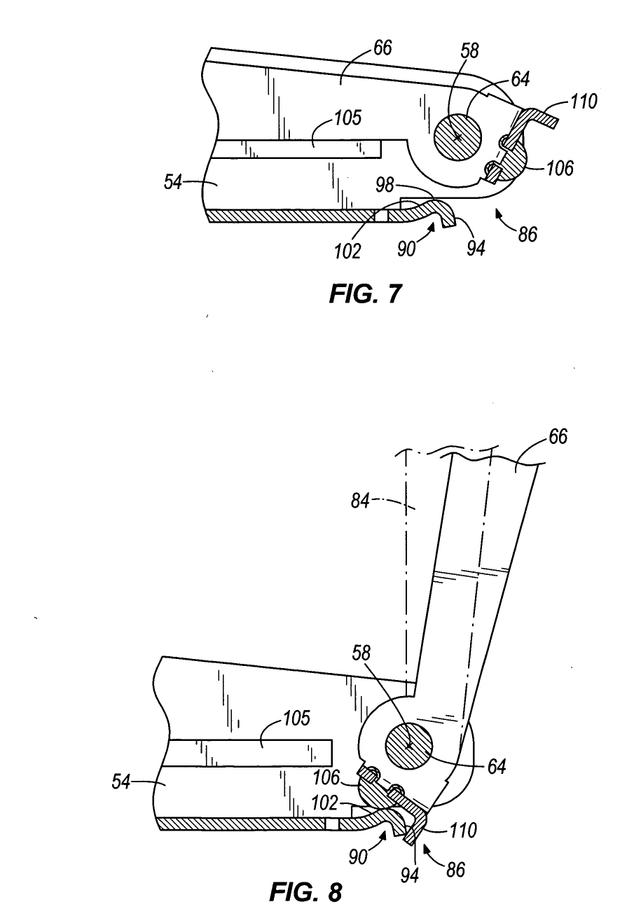

With reference to FIGS. 2-8, the stapler 14 includes a case 66 also pivotally connected to the base 22 about the pivot axis 58. The case 66 is capable of pivoting with the cover 62 and with respect to the cover 62 during stapling operations. Together, the case 66 and cover 62 form a cover assembly. The case 66 at least partially closes the upper portion of the magazine 54 when the cover 62 is in the closed position, illustrated in FIGS. 1 and 7, and pivots with the cover 62 to the open position, illustrated in FIGS. 2 and 8, for re-filling the magazine 54 with staples. It is understood that since the case 66 and the cover 62 pivot together during the staple refilling portion of the stapling operations, any action performed on one of the case 66 or the cover 62 will also be performed on the other of the case 66 or the cover 62 during staple refilling. Thus, where it is described in this application that the case 66 or cover 62 is acted upon, it is implicit that the other of the case 66 or cover 62 is also acted upon.

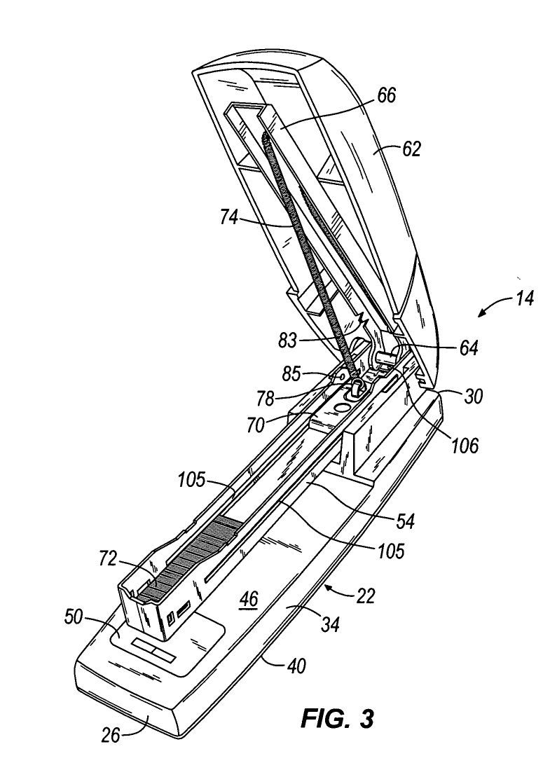

With reference to FIGS. 2 and 3, the stapler 14 also includes a staple pusher 70 housed within the magazine 54. The staple pusher 70 biases staples 72 toward the front of the staple magazine 54 when the stapler 14 is in the closed position. The staple pusher 70 is biased by a spring 74 having a first end 78 coupled to the staple pusher 70 and a second end 82 coupled to the case 66. The spring 74 also acts to bias the case 66 in the closed position due to the tension in the spring 74. As the case 66 is pivoted into the open position, the force of gravity pulling downwardly on the case 66 will overcome the biasing force of the spring 74 at some point after the case 66 passes the vertical position 84, shown in shadow in FIG. 8. While the spring arrangement illustrated utilizes what is typically known as an extension spring arrangement, it is to be understood that other spring arrangements (e.g., known constant force spring arrangements) can also be used with the present invention.

The stapler 14 is biased toward the closed position due to the force of the spring 74 and by the force of gravity, and is generally locked in the closed, stapling position due to interaction between the case 66 and the magazine 54. In the stapler of the illustrated embodiment, the case 66 includes a tab 83 that is biased slightly outwardly that is received by a recess 85 in the magazine 54. It is understood by one of skill in the art that other devices, which may be located in other positions on the stapler 14, could be used to lock the stapler 14 in the closed position.

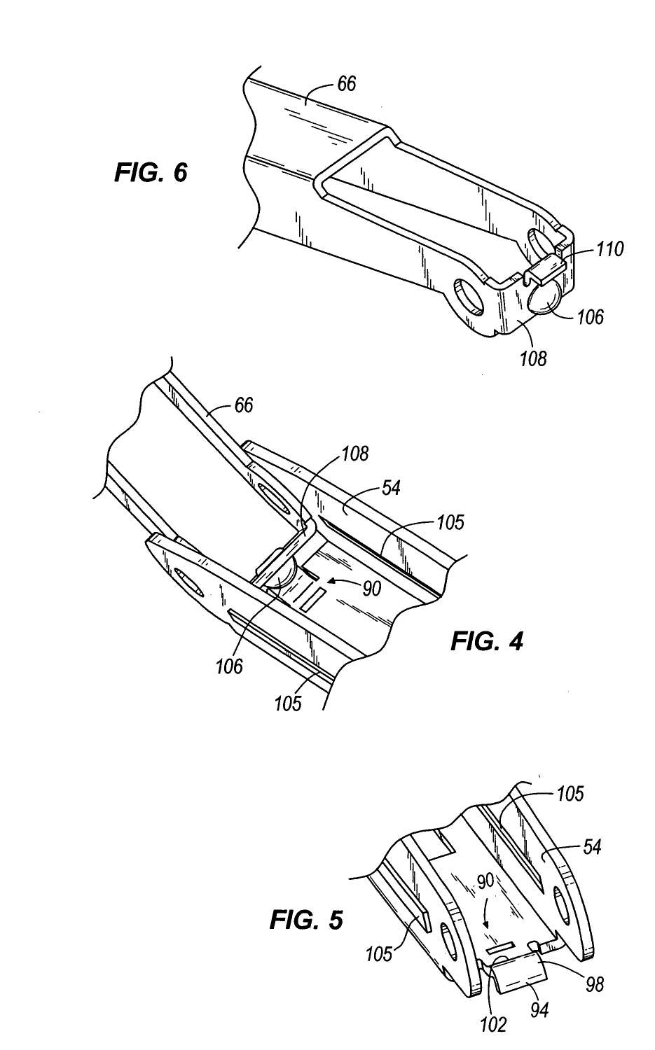

The stapler 14 further includes a holding device 86 for holding the case 66 in the open position against the force of the spring 74 and/or the force of gravity, as illustrated in FIGS. 4-8. The device of the illustrated embodiment includes a detent 90 on the magazine 54 that has a first side 94, a crown 98, and a second side 102. The detent 90 is cantilevered from the bottom surface of the magazine 54. The magazine configuration including the detent 90 is shown in detail in FIGS. 5, 7, and 8.

In some embodiments, such as the embodiment shown in FIGS. 2-5, 7, and 8, the magazine 54 includes a channel 105 in each of the side walls of the magazine 54 to help guide the staples in the magazine 54. It is understood that in other embodiments, the magazine does not include the channel in the side walls. In still other embodiments (not shown), the magazine can include a rail on which the staples ride to guide the staples to the front of the stapler.

The illustrated holding device 86 also includes a protrusion 106 coupled to an extension 108 of the case 66 (best shown in FIGS. 4 and 6). The protrusion 106 cooperates with the detent 90 to hold the case 66 in the open position while a user is refilling the staple supply. The configuration of the case 66 including the protrusion 106 and the extension 108 is shown in detail in FIGS. 4 and 6. In the illustrated embodiment, the protrusion 106 is the head of a rivet, but it is understood that in other embodiments, the protrusion can have other configurations and could be integrally formed with the case.

The interaction between the detent 90 and the protrusion 106 overcomes the tendency of the case 66 to close due to the biasing force of the spring 74 and/or the force of gravity. As the case 66 is pivoted from the closed to the open position (shown in FIGS. 7 and 8, respectively), the protrusion 106 travels from the first side 94 of the detent 90, over the crown 98, and rests against the second side 102 of the detent 90. Those skilled in the art will understand that while the illustrated embodiment shows the detent 90 on the magazine 54 and the protrusion 106 on the case 66, the detent 90 and the protrusion 106 could also be reversed such that the detent 90 is on the case 66 and the protrusion 106 is on the magazine 54.

In the illustrated embodiment, the detent 90 is semi-cylindrical and the protrusion 106 is hemispherical in configuration. However, it is understood that in other embodiments, the detent 90 and the protrusion 106 can have configurations of any appropriate shape, so long as one includes a protrusion over which a portion of the other travels to hold the case open until it is closed by the user. Such appropriate shapes could include, but are not limited to, oval, helical, polygonal, triangular, or otherwise curved. In other embodiments, the mechanism could include a ball and spring on one part that cooperates with an aperture or recess in the other part, a protrusion on one part that cooperates with a notch, aperture, or recess on the other part, or other known retention mechanisms. In still other embodiments, the mechanism could include a hook on one part that cooperates with a portion of the other part to hold the case in the open position. In some mechanisms, the hook may have to be separately actuated to release the lock holding the case open.

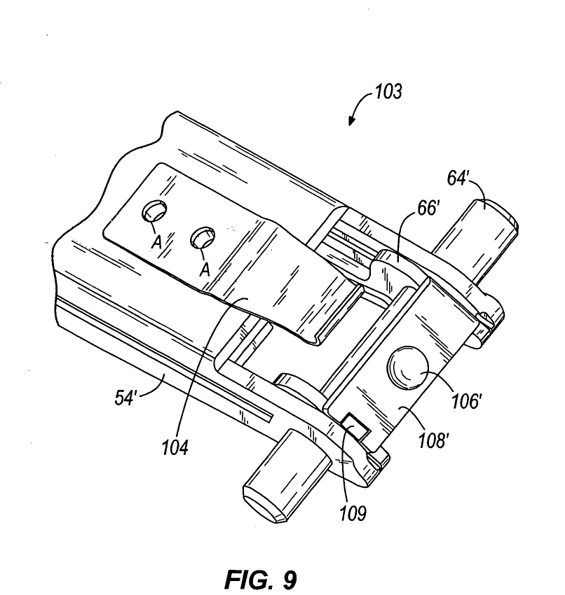

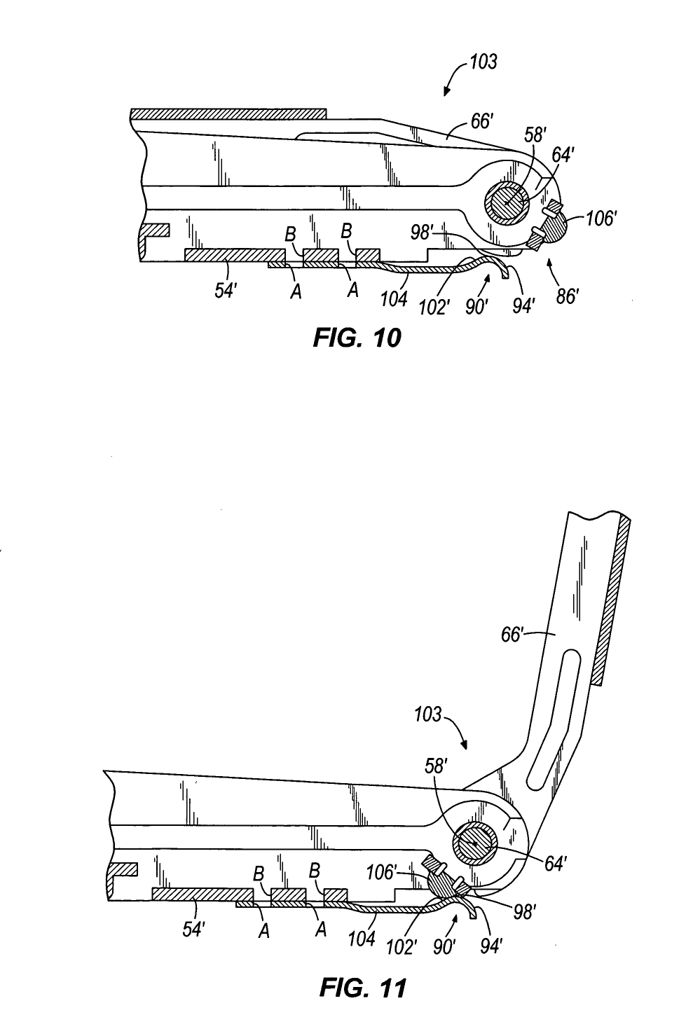

FIGS. 9-11 illustrate another embodiment of a stapler sub-assembly 103 that can be used with the stapler 14. Unlike the detent 90 that is formed with the magazine 54, the sub-assembly 103 includes a leaf spring 104 that can be coupled to the magazine 54′. As illustrated in FIGS. 9-11, the leaf spring 104 includes apertures A that are aligned with apertures B formed in the magazine 54′, and that are sized to receive fasteners (e.g., rivets—not shown) that secure the leaf spring 104 to the magazine 54′. Of course, other methods of securing the leaf spring 104 to the magazine 54′, such as welding, brazing, adhesives, and the like, are contemplated.

The leaf spring 104 defines a detent 90′ having a first side 94′, a crown 98′, and a second side 102′. The detent 90′ and protrusion 106′ operate in substantially the same manner described above and below during opening and closing of the sub-assembly 103. As further illustrated in FIG. 9, the extension 108′ includes an interlocking protrusion 109 that helps maintain the position of the extension 108′ during detent actuation. Other similar features have been given the same numerals designated as prime (′).

In the embodiment illustrated in FIGS. 1, 6, 7, and 8, the case 66 also includes a stop member 110 that is spaced from the protrusion 106 and extends outwardly from the case 66. The stop member 110 is coupled to the case by the rivet or protrusion 106. However, it is understood that in other embodiments the stop member can be integrally formed with the case. It is also understood that in other embodiments, the stapler 14 may not include the stop member 110 at all.

The stop member 110 is substantially L-shaped, but it is understood by one of skill in the art that the stop member 110 could be any appropriate shape and still fall within the scope of the invention. The stop member 110 is spaced from the protrusion 106 such that when the protrusion is in contact with the second side 102 of the detent 90 when the case 66 is in the open position, the stop member 110 rests against the first side 94 of the detent 90 to prevent overrotation of the case 66.

FIGS. 7 and 8 illustrate the stapler 14 as the stapler is moved from the closed to the open positions. To open the stapler 14 to reveal the magazine 54, a user grasps the cover 62 and pivots the cover 62 and the case 66 away from the magazine 54, overcoming the biasing force of the overcenter spring 74 and the tab 83 to release the tab 83 from the recess 85 in the magazine 54. As the protrusion 106 contacts the first side 94 of the detent 90, the user exerts force on the cover 62 away from the magazine 54, causing the protrusion 106 to ride over the crown 98 of the detent 90 and contact the second side 102 of the detent 90. The stop member 110 then contacts the first side 94 of the detent 90 to prevent further rotation of the case 66 with respect to the magazine 54. Thus, the protrusion 106 rests against the second side 102 of the detent 90.

When the user wishes to close the stapler 14, the user exerts force on the cover 62 in the direction toward the magazine 54. The force causes the protrusion 106 to travel back over the crown 98 of the detent 90, releasing the engagement between the protrusion 106 and the detent 90, allowing the case 66 and cover 62 to close. The case 66 is secured to the magazine 54 such that the stapler 14 is again in the stapling position.

Various features of the invention are set forth in the following claims.

1. A stapler comprising:
a base;
a magazine for receiving staples, the magazine being coupled to the base;
a cover assembly coupled to the base, the cover assembly pivotable between an open position and a closed position with respect to the magazine; and
a holding device coupled to the stapler that holds the cover assembly in the open position with respect to the magazine when the cover assembly is pivoted to the open position.

2. The stapler of claim 1, further comprising a spring, wherein the spring biases the cover assembly toward the closed position.

3. The stapler of claim 2, wherein the holding device overcomes the biasing force of the spring when the cover assembly is pivoted to the open position.

4. The stapler of claim 1, wherein the cover assembly includes a case coupled to a cover, wherein the case includes a tab, and wherein the magazine includes a recess that cooperates with the tab to secure the case in the closed position.

5. The stapler of claim 1, wherein the holding device includes a detent on one of the magazine and the cover assembly and a protrusion on the other of the magazine and the cover assembly that cooperates with the detent to hold the cover assembly in the open position.

6. The stapler of claim 5, wherein the protrusion includes a rivet.

7. The stapler of claim 5, wherein the one of the detent and the protrusion on the magazine is cantilevered with respect to the magazine.

8. The stapler of claim 1, wherein the holding device includes a leaf spring coupled to the magazine, the leaf spring defining one of a detent and a protrusion that cooperates with one of a detent and a protrusion on the cover assembly to hold the cover assembly in the open position.

9. The stapler of claim 1, wherein the cover assembly includes a stop member that prevents overrotation of the cover assembly with respect to the magazine.

10. A stapler comprising:
a base;
a magazine for receiving staples;
a cover pivotally coupled to the base;
a case being pivotally coupled to the magazine and movable between an open position and a closed position with respect to the magazine; and
a holding device that holds the case in the open position with respect to the magazine when the case is pivoted into the open position, the holding device including a portion of the case and a portion of the magazine that cooperate to hold the case in the open position.

11. The stapler of claim 10, further comprising a spring coupled to the case, wherein the spring biases the case toward the closed position.

12. The stapler of claim 10, wherein the holding device includes a detent on one of the magazine and the case and a protrusion on the other of the magazine and the case that cooperates with the detent to hold the case in the open position.

13. The stapler of claim 12, wherein the one of the detent and the protrusion on the magazine is cantilevered with respect to the magazine.

14. The stapler of claim 10, wherein the holding device includes a leaf spring coupled to the magazine, the leaf spring defining one of a detent and a protrusion that cooperates with one of a detent and a protrusion on the case to hold the case in the open position.

15. The stapler of claim 10, wherein the case includes a stop member.

16. The stapler of claim 15, wherein the stop member is substantially L-shaped.

17. A method of holding a stapler open to inhibit the stapler from closing unexpectedly, the stapler including a base, a staple magazine, and a cover assembly, the method comprising:
biasing the cover assembly toward a closed position with respect to the staple magazine;
pivoting the cover assembly toward an open position with respect to the staple magazine;
overcoming the bias toward the closed position such that a user has access to the staple magazine; and
engaging the cover assembly and the staple magazine to thereby hold the cover assembly in the open position.

18. The method of claim 17, wherein the cover assembly includes a cover and a case, and wherein engaging the cover assembly and the staple magazine includes moving a protrusion on one of the case and the staple magazine over a detent on the other of the case and the staple magazine to inhibit the cover assembly from closing unexpectedly with respect to the magazine.

19. The method of claim 18, wherein the stapler further includes a leaf spring coupled to the magazine, the leaf spring defining the one of the protrusion and the detent on the magazine, and wherein engaging the cover assembly and the staple magazine includes moving the one of the protrusion and the detent on the case over the one of the protrusion and the detent defined by the leaf spring.

20. The method of claim 17, further comprising preventing overrotation of the cover assembly with respect to the magazine, wherein preventing overrotation includes providing a stop member.

21. The method of claim 17, further comprising closing the stapler, wherein closing the stapler includes
disengaging the engagement between the cover assembly and the magazine so that the cover assembly is biased toward the closed position, and
pivoting the cover assembly to the closed position.
